(19) United States
(12) Patent Application Publication
(10) Pub. No.: US 2023/0253128 A1
(43) Pub. Date: Aug. 10, 2023

(54) ENGINE COMPRISING A DEVICE FOR INDUCING NUCLEAR FUSION REACTIONS BY ACCELERATED IONS

(71) Applicant: Bruno SANGLE-FERRIERE, Paris (FR)

(72) Inventor: Bruno SANGLE-FERRIERE, Paris (FR)

(21) Appl. No.: 18/102,449

(22) Filed: Jan. 27, 2023

(30) Foreign Application Priority Data
Feb. 9, 2022 (FR) 2201138

(51) Int. Cl. G21D 5/02; G21B 3/00; G21F 3/00; F02K 7/16

(52) U.S. Cl. CPC G21D 5/02; G21B 3/006; G21F 3/00; F02K 7/16; F05D 2220/323

(57) ABSTRACT

The engine includes a chamber having an intake and an output for a fluid; a first enclosure configured to contain a source material; a system for at least partially ionizing the source material; and an ion accelerator configured to accelerate the ionized source material towards the chamber so as to cause the fusion of atomic nuclei of the ionized source material with atomic nuclei of the fluid.

### TECHNICAL FIELD

The present invention relates to an engine powered at least partially by inducing nuclear fusion reactions. The invention particularly relates to a jet engine in which the thrust is produced by the heating and expansion of a fluid passing through the engine, the heating being obtained by the slowing of a beam of accelerated ions and the release of heat generated by the nuclear fusion reactions. When the fluid passing through the engine is an alkane, it is also possible to generate hydrogen and carbon by pyrolysis.

Within the scope of the invention, “nuclear fusion” is given to mean a process by which two atomic nuclei are combined to form a heavier nucleus. This differs in particular from spallation, in which the nucleus struck by an incident particle disintegrates due to the impact.

### PRIOR ART

It is known practice to induce fuel combustion in a cavity in order to cause the formation of a gas or the expansion due to heating of a gas. The ejection of the gas at high speed makes it possible to obtain thrust in the opposite direction to the ejection of the gas.

In addition to the combustion a fuel, there are other methods for heating a gas in order to obtain thrust. It is known practice, for example, to use electricity to heat the gas.

Ion thrusters, in which ions are accelerated by an electric field in order to generate thrust, are known in particular in the field of space transport.

Reactors inducing heat production by nuclear fission have also been proposed, in particular in the field of space transport.

CN113090387A discloses an aircraft engine powered by a nuclear fission generator. The engine disclosed aims to limit the safety risks in the event of the failure of the engine. To this end, a cooling control unit is provided, configured to supply emergency cooling in the event of a failure.

CN1269308A discloses a device for accelerating ions used to accelerate an air stream by heating and thus generate thrust.

The existing engine solutions can however be further improved, in particular by proposing alternative methods for generating nuclear reactions and thrust.

In addition, the existing methods for pyrolysis of an alkane use the combustion of hydrocarbons to heat the alkane, and co-produce carbon dioxide or electricity. These methods can be improved, in particular by proposing alternative methods for heating the alkane.

The aim of the invention is to at least partially meet this need.

### DISCLOSURE OF THE INVENTION

To this end, the invention relates, according to one aspect thereof, to an engine comprising:
a chamber comprising an intake and an output for a fluid;
a first enclosure configured to contain a source material;
a system for at least partially ionizing the source material;
an ion accelerator configured to accelerate the ionized source material towards the chamber so as to cause the fusion of atomic nuclei of the ionized source material with atomic nuclei of the fluid.

According to the invention, ions can thus be accelerated at a sufficient speed so that on impact with atomic nuclei of the fluid, the kinetic energy accumulated by the accelerated ions allows the nuclei of the accelerated ions and of the fluid to fuse.

If the ions are accelerated at a sufficient speed and if an inner wall of the chamber is sufficiently close to the output of the ion accelerator, the accelerated ions can strike the inner wall and heat it, but also react by nuclear fusion with it.

The engine according to the invention advantageously makes it possible to heat and expand the fluid passing through the engine, thus generating thrust. The heat is generated by two mechanisms: firstly, nuclear fusion reactions are selected because they are exothermic and therefore capable of heating the fluid; secondly, the slowing of the accelerated ions in the fluid heats the fluid due to the Bragg effect.

The fluid can come from outside the engine, in which case the fluid is preferably air. The fluid can equally come from a fluid reserve, the reserve containing a gas or a liquid. The fluid can be stored directly in the fluid reserve, and it can also be produced by the reaction of a second fluid stored in the fluid reserve with another product. The reaction can in particular be combustion between a fuel and a comburent.

Advantageously, the fluid can be conveyed to the chamber in liquid or solid form in a step of starting the engine, then in gaseous form in a step of nominal operation of the engine.

The fluid, accelerated by the reactor in the chamber, can advantageously be accelerated again at the output of the chamber, for example by an ion thruster. The electricity consumed by such an ion thruster comes for example from an auxiliary electricity generator and/or is produced by converters converting the heat energy produced by the reactor into electrical energy.

The advantages of the engine according to the invention include: the possibility of avoiding the use and production of radioactive materials as generated by nuclear fission reactors, the absence of chain reactions and therefore instabilities, the almost instantaneous responsiveness of the thrust of the reactor by modulating the production and acceleration of the ions, and the considerable increase in the range of vehicles using such an engine compared with a conventional jet engine, as a nuclear fusion reaction releases over ten million times more energy per unit of mass than the combustion of a fossil fuel.

Ionization

According to a particular embodiment, the system for ionizing the source material comprises:
a laser,
an input waveguide configured to guide the light emitted by the laser towards an optical input of the first enclosure, the optical input being configured to allow the illumination of the source material by the light emitted.

The laser can be configured to emit light the wavelength and instantaneous power of which are sufficient to allow the ionization of the source material. The ionization system can also comprise a wave concentrator configured to superpose a plurality of cycles of the light emitted by the laser in order to both increase the instantaneous power of the light emitted and produce ions in bursts rather than continuously, the wave concentrator preferably being a coherent amplification network. In addition, the device can advantageously include an output waveguide configured to guide light not absorbed by the source material from an optical output of the enclosure towards the optical input of the enclosure, and the enclosure can comprise a plurality of mirrors configured to reflect the light emitted by the laser between the optical input and the optical output so as to illuminate the source material several times.

Alternatively or in combination, the wavelength of the laser is divided in two using a four-wave mixing process.

Alternatively or in combination, the ionization system comprises LEDs producing UVC configured to ionize the source material.

According to an alternative embodiment, the ionization system can comprise an X-ray source configured to irradiate the source material.

The ionization of the source material is thus obtained, for example, by the irradiation of the source by X-rays produced by an X-ray generator, preferably an X-ray tube, placed in the first enclosure containing the source material. The X-rays emitted by said tube preferably have a wavelength less than the Planck constant multiplied by the speed of light in a vacuum and divided by the ionization energy of the source material.

X-ray ionization is preferably used for solid or liquid source materials. As X-rays are highly ionizing, the source material is ionized with a loss of several electrons, increasing the Bragg effect of the penetration of the source ions into the target material and also the kinetic energy accumulated during their acceleration and therefore their power to heat the target material.

The ionization material is preferably heated to a temperature at which it is in a gaseous state. This is particularly advantageous if it is sulphur, potassium, phosphorus, lithium or sodium.

Acceleration

The ion accelerator is configured to accelerate the ions obtained from the source material by electric fields, either in linear accelerators able to accelerate continuous ion fluxes with continuous voltages, or in cyclotrons, synchrotrons or synchrocyclotrons that can accelerate ion bursts orbiting under the effect of a magnetic field between two D-shaped concave electrodes the potential difference of which alternates between positive and negative so that the ions are accelerated when they pass through the zone separating the two volumes delimited by the dees.

According to one embodiment, the ion accelerator is linear. The ion accelerator comprises a high-voltage generator, electrically connected to a first electrode arranged in the first enclosure and to a second electrode, the second electrode being arranged in the chamber, the generator and the first and second electrodes being configured to generate an electric field making it possible to accelerate the ionized source material towards the chamber so as to cause the fusion of the atomic nuclei of the ionized source material with atomic nuclei of the fluid.

Alternatively, the second electrode can be situated outside the chamber, for example in a second enclosure separated from the first enclosure by a wall that is permeable to the ions but impermeable to the target material; the electrons meet the accelerated ions before reaching the chamber in order to form particles with a neutral electric charge. Said particles are then preferably ionized again before they enter the chamber by exposure to ultraviolet or X-ray light, for example of the same type as the light used for the ionization prior to acceleration. An electric field perpendicular to the direction of the particles then makes it possible to extract the electrons.

The first electrode is preferably arranged near an ionization region of the source material, the source material preferably being ionized between the first and second electrodes.

According to an alternative embodiment, the ion accelerator comprises a cyclotron and/or a synchrotron and/or a synchrocyclotron configured to accelerate the ionized source material towards the chamber so as to heat the fluid and additionally cause the fusion of the atomic nuclei of the ionized source material with atomic nuclei of the fluid.

Preferably, the ions of the ionized source material are sent in bursts into the cyclotron or synchrotron. The magnetic field of a cyclotron is fixed, while the magnetic field of a synchrotron is variable.

The ions can leave the cyclotron or the synchrotron to reach the fluid and optionally a wall of the chamber, for example through the momentary interruption of the magnetic field used to cause the ions to orbit between the two elements of the synchrotron or the cyclotron, or on the periphery of the cyclotron, the ions then continuing on their straight trajectory instead of orbiting in the next element.

The inner walls of the cyclotron or synchrotron, together with the walls of the optional maintenance electrodes described below, are advantageously coated with dielectric layers, for example made from a polymer or glass, through which electrons cannot pass despite the presence of electric fields resulting from the potential difference applied to said electrodes.

According to an alternative embodiment, the ion accelerator comprises a combination of linear accelerators and cyclotrons or synchrotrons. The ions from a first linear accelerator are thus for example injected into a cyclotron close to its centre, to be directed at the output towards a second linear accelerator, for example. If the ions are injected into the cyclotron at a speed having a non-zero component along the axis of the cyclotron, an electric field with the same direction and opposite sense generated by electrodes situated near to or surrounding the centre of the cyclotron is preferably provided, the electric field tending to cancel out this component of speed along the axis of the cyclotron, preferably when the ions re-enter the cyclotron or synchrotron.

The ion accelerator is preferably empty of gas, that is, with a pressure below 10⁻⁵ bar. This makes it possible to apply a significant acceleration voltage without fear of breakdown, that is, the ionization of the gas under the effect of the electric field. This significant voltage allows the rapid acceleration of the ions in the place where they are created. The ion accelerator is thus preferably protected at the input and output of each of its components (linear accelerator, cyclotron, synchrotron) by membranes that are permeable to the ions and impermeable to the gases present outside, and provided with one or more pumps making it possible to create a vacuum within the components of the ion accelerator. The ion accelerator is then preferably configured so that said membranes can be replaced periodically or continuously, as they can degrade during nuclear reactions with the accelerated ions or simply by heating due to the ions passing through them. The separating membrane, in particular if the accelerator is linear or if it is a cyclotron, can also be situated within the accelerator, in particular if the second electrode is in the chamber, thus making it possible to heat the fluid passing through said chamber due to the Bragg effect. If the accelerator is a cyclotron, the space situated between the two dees is then split in two by a wall, said wall being permeable to the ions in the place where they pass through it.

The engine according to the invention can also comprise one or more of the following optional features:
the engine comprises one or more coils surrounding and/or around the beam of accelerated ions, acting as magnetic lenses to concentrate the ion beam or keep it concentrated,
if the source material is solid or liquid, the first enclosure preferably comprises a support made from a light-transparent material and configured to hold said source material,
if the source material is gaseous, the first enclosure preferably comprises a gas intake and a gas output configured to allow the source material in gaseous form to flow between the gas intake and the gas output so that the path of the source material intersects the path of the ionizing light,
the first enclosure comprises a membrane that is permeable to the ionized source material and impermeable to the non-ionized source material and arranged between the first and second electrodes, the membrane preferably consisting of a plurality of layers, preferably 6, of hexagonal boron nitride,
the engine preferably comprises a coil arranged around the first enclosure and centred on an axis passing through the intersection of the path of the source material and the path of the ionizing light, the coil being configured to generate a magnetic field, for example of 1.5 Tesla, tending to keep the ionized source material in line with the acceleration magnetic field,
the inner wall of the first enclosure is at least partially coated with a dielectric material,
the engine preferably comprises an intermediate electrode arranged between the first electrode and the target and connected to a second generator connected to the second electrode, the intermediate electrode consisting of a gate and/or a conductive membrane, made from graphene for example,
the chamber comprises a plurality of fins, preferably made from a heat-conducting material such as a metal, in particular tungsten, iron or stainless steel, the fins being configured to absorb the gamma radiation emitted by the fusion of the nuclei of the source material with the nuclei of the fluid and transmit their heat to the fluid passing through the chamber,
the walls of the chamber comprise one or more first target materials, the ion accelerator being configured to accelerate the ionized source material towards the first target materials so as to cause the fusion of nuclei of the ionized source material with nuclei of the first target materials, preferably forming a stable isotope, said first target materials preferably forming a coating of the inner walls of the chamber,
the chamber comprises one or more maintenance electrodes configured to form an electric field accelerating the ionized source material,
the outer walls of the chamber are coated with a shield configured to reflect heat radiation towards the inside of the chamber,
the engine comprises a second enclosure arranged between the first enclosure and the chamber and comprising a second target material, the ion accelerator being configured to accelerate the ionized source material towards the second target material so as to cause the fusion of nuclei of the ionized source material with nuclei of the second target material,
the second target material is a fluid flowing in a cooling circuit,
the second chamber comprises a heat-transfer liquid, the heat-transfer liquid flowing in a cooling circuit,
the second enclosure comprises a heat-transfer liquid, the heat-transfer liquid flowing in a heat-transfer liquid cooling circuit,
the cooling circuit being configured to transmit the heat recovered to a device for converting the heat energy into electricity,
the chamber comprises at least one shield against gamma radiation configured to prevent the emission of gamma radiation through the intake and/or through the output of the chamber, in particular for the gamma radiation produced by the nuclear reactions,
the engine comprises one or more sensors configured to measure the deformation of the engine and/or the temperature of the engine and/or the acceleration of parts of the engine,
the fluid is a gas, in particular air,
the source material is an isotope that produces a stable isotope on fusion with nitrogen 14 and/or oxygen 16, preferably lithium 7, boron 11, fluorine 19, beryllium 9, tritium, nitrogen 15 or carbon 13,
the fluid is an alkane, in particular methane,
the source material is selected so that the product of the fusion of the source material with carbon 12 and/or hydrogen is a stable isotope, the source material preferably being sodium 23 or fluorine 19,
the engine is used to heat the fluid to a temperature of between 1,200° C. and 2,000° C., the fluid being an alkane. This makes it possible to break the alkane down by pyrolysis into carbon and hydrogen,
the engine comprises a filter, in particular a bag filter, configured to separate carbon and hydrogen, the filter being arranged at the output of the chamber,
the engine comprises an electricity-generating turbine arranged at the output of the chamber,
the engine comprises a second cooling circuit configured so that a second heat-transfer liquid flows in the walls of the chamber, the heat transported by the second heat-transfer liquid preferably being used to generate electricity,
the engine forms a ramjet engine,
the engine comprises a compressor arranged at the intake of the chamber and forms a turbojet engine,
the engine comprises a fluid reserve fluidly connected to the intake of the chamber,
the fluid is stored in gaseous or liquid form in the fluid reserve or the fluid is a gas produced by chemical reaction of a liquid stored in the fluid reserve, in particular by combustion.

Within the scope of the invention, “heat-conducting material” is given to mean a material in the solid state the heat conductivity of which is greater than or equal to 5 W/m/K.

“Heat-transfer material” is given to mean a fluid the heat conductivity of which is greater than or equal to 0.1 W/m/K and the heat capacity of which is greater than or equal to 0.1 kJ/kg/K.

The invention also relates to an aircraft comprising an engine according to the invention and to a spacecraft comprising a motor according to the invention. The spacecraft preferably comprises a tank configured to contain the fluid and to inject the fluid into the intake of the chamber and/or a material configured to sublimate.

### BRIEF DESCRIPTION OF THE DRAWINGS

FIG. 1 diagrammatically shows a first embodiment of the engine according the invention.

FIG. 2 is a front view of an engine according to the invention using a plurality of devices for inducing nuclear fusion reactions.

FIG. 3 illustrates a second embodiment of the engine according to the invention.

FIG. 4 shows a third embodiment of the engine according the invention.

FIG. 5 shows an ion accelerator of a fourth embodiment of the engine according the invention.

FIG. 6 is a side view of an engine comprising the ion accelerator described in FIG. 5.

FIG. 7 illustrates an ion accelerator of a fifth embodiment of the engine according the invention.

FIG. 8 shows an ionization system that can be implemented in an engine according to the invention.

### DETAILED DESCRIPTION

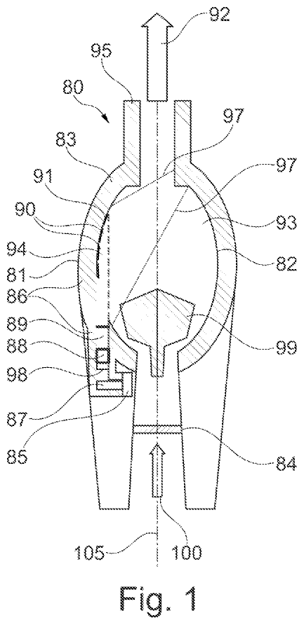

In the embodiment illustrated in FIG. 1, the engine 80 according to the invention is a jet engine, and can be a turbojet engine or a ramjet engine.

The engine 80 in FIG. 1 extends along an axis 105 and comprises a gamma ray shield 86 forming a chamber 93.

A fluid such as air enters the engine 80 through the intake 100 of the chamber 93, optionally compressed by a compressor 84 if the engine 80 is a turbojet engine. It is then heated in the chamber 93, in particular by a flux of ions slowed by the Bragg effect and undergoing a nuclear reaction with the dinitrogen and dioxygen of the pressurized air, along the wall of the cavity.

An ion generator 85 produces ions, for example boron ions. The ions are directed towards a linear ion accelerator 87 configured to accelerate the ions. Preferably, the inner wall of the ion accelerator 87 is coated with a dielectric material, preventing electrons from being detached from it.

At the output of the accelerator 87, the ions enter a first enclosure 88, advantageously configured to allow first nuclear reactions with target materials contained in the enclosure 88, for example dihydrogen or dideuterium maintained at a pressure greater than their critical pressure, for example at 15 atmospheres, or lithium 6 or 7 or boron 10 or 11.

The first enclosure 88 comprises first maintenance electrodes 98 making it possible to maintain the speed of the ions within the material that they pass through by compensating for the loss of kinetic energy. The enclosure 88 can advantageously contain a plurality of different materials, in particular if they are separated by maintenance electrodes, thus making it possible to heat these target materials to different temperatures and with different powers appropriate to the chemical reactions used to generate electricity. Second maintenance electrodes 89 arranged at the output of the enclosure 88 accelerate the ions in the compressed fluid inside the engine towards the last electrode 91, arranged on the inner wall of the shield 86. The ions from nuclear reactions with the molecules of the fluid are electrically neutralized by the electrodes 90, arranged on the inner wall of the shield 86 between the second maintenance electrodes 89 and the last electrode 91.

The ions thus produce heat due to the Bragg effect. They optionally produce gamma radiation inside a section 94 of the jet engine 80, the radiation being generated by the fusion reactions between the ions and nuclei of the optionally compressed fluid within the jet engine 80. The section 94 is defined by the electrodes 89, 90, 91. The radiation produced in the section 94 partially propagates in the chamber 93. The geometry of the jet engine 80 is such that the radiation is however stopped regardless of its direction by gamma ray shields 95 and 99 protecting the output 92 and the intake 100 of the device respectively. The geometry of the engine 80 thus defines a volume 97 within the device that is irradiated by the gamma radiation produced by the fusion reactions of the accelerated ions with the fluid.

The gamma ray shield 86 is for example made from tungsten, iron or stainless steel and coated with an infrared radiation shield 81, optionally having low heat conductivity. The shield 81 reflects the radiation and preferably slows the heat flux generated by certain parts of the engine. The inner wall of the gamma ray shield is preferably coated with a dielectric coating 82. A heat-transfer liquid 83, for example liquid lead, can flow within the gamma ray shield 86 to recover the heat produced. The thickness of the gamma ray shield is advantageously variable (not shown) as a function of the position relative to the gamma ray emission sources.

The heat-transfer liquid 83 and/or the target materials contained in the first enclosure 88 advantageously flow in a cooling circuit in order to be cooled and transmit the heat to a device for converting heat energy into electricity. This advantageously makes it possible to supply electricity to the ion accelerator 87 and to the electrodes 89, 90 and 91, and/or to other electrical appliances contained in the engine or outside it. This conversion device, the electrodes 89, 90, 91, the ion generator 85, the ion accelerator 87, the first enclosure 88 and the heat-transfer liquid 83 make up an assembly forming a device for heating the air due to the Bragg effect and inducing nuclear fusion reactions.

The speed of the ions at the output of the enclosure 88 is in particular determined by the intensity of the electric field generated by the electrodes 89, 90 and 91, and the quantity of ions produced depends on the ionizing light flux and the source material concentration of the ion generator 85, which thus make it possible to control the heating power of the fluid of the engine. The modulation of the pressure in the enclosure 88, for example by partial evacuation, can also make it possible to control the share of energy used for electricity production by heat conversion.

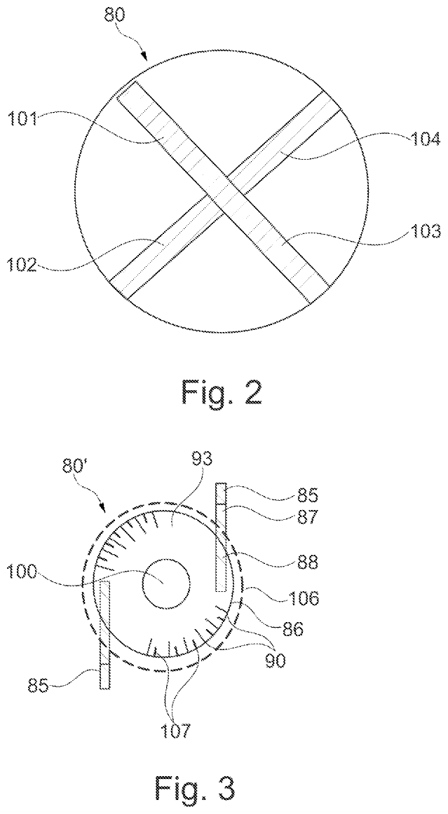

FIG. 2 shows a front view of an engine 80 comprising a plurality of devices 101, 102, 103, 104 for heating due to the Bragg effect and inducing nuclear fusion reactions, each configured like the device described in the embodiment in FIG. 1. The devices 101, 102, 103, 104 can be arranged angularly evenly about the axis 105.

FIG. 3 shows a second embodiment of the engine 80′ according to the invention.

The engine 80′ differs from the engine 80 in FIG. 1, in particular in that the ion accelerators 87 are oriented along an axis perpendicular to the axis of the engine.

As in the embodiment in FIG. 1, the engine 80′ comprises a wall 86 forming a chamber 93. A fluid such as air enters the engine 80 perpendicular to the plane of the figure through the intake 100 of the chamber 93, optionally compressed by a compressor if the engine 80 is a turbojet engine. It is then heated in the chamber 93.

Two ion generators 85 produce ions, for example boron ions. The ions are directed towards the ion accelerators 87 configured to accelerate the ions, which flow and are slowed in the chamber 93 in a straight line in the volume 88, or in a circle about the axis of revolution of the walls if a magnetic field is applied along this axis.

It can also be envisaged that the engine 80′ comprises just one generator and one accelerator, or conversely, comprises more than two. It can also be envisaged that the engine 80′ does not comprise an ion accelerator 87, and in this case the ions coming from the ion generators 85 are only accelerated by the electrodes 90 arranged on the inner face of the wall 86.

The electrodes 90 can also be used as maintenance electrodes configured to maintain the speed of the ions accelerated by the accelerators 87.

Preferably, the electric fields generated by the electrodes 90 are continuous if the ions are generated in a continuous flux, or alternating if the ions are sent in bursts; if the ions are sent in bursts, the frequency of the electric fields is determined so that the electric field is oriented in the direction of propagation of the ions when they pass through it.

Advantageously, a coil 106 is arranged around the wall 86, level with the ion generators 85 along the axis of the engine. The coil 106 is configured to generate a magnetic field tending to make the trajectory of the ions within the chamber 93 circular.

Preferably, fins 107 are arranged on an inner face of the wall 86 in order to improve the heat exchanges with the fluid. The fins 107 advantageously have a reduced length so that they are not on the trajectory of the accelerated ions in the chamber. Alternatively, the fins 107 can also act as electrodes and the ions can pass through them, in which case nuclear fusion reactions with the nuclei of the fins can take place.

Advantageously, the wall 86 comprises one or more energy capture devices, in particular a flow of heat-transfer fluid.

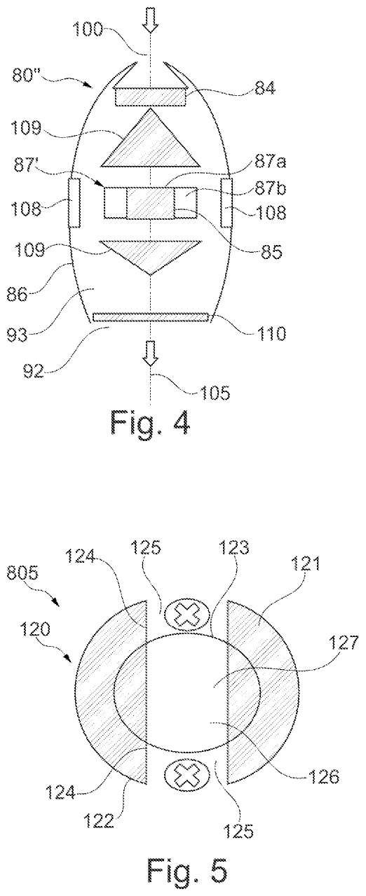

FIG. 4 illustrates a third embodiment of an engine 80″ according to the invention. This engine 80″ differs from the one shown in FIG. 1, in particular in that it comprises a cyclotron as the ion accelerator.

The engine 80″ comprises a wall 86 defining a chamber 93 and which can be a gamma ray shield. The engine also comprises a fluid intake 100 and an output 92. If the engine is a turbojet engine, it comprises a compressor 84 arranged at the intake 100.

A device for inducing nuclear fusion reactions is arranged in the chamber 93 and comprises an ion generator 85 and an ion accelerator 87′, which takes the form of a cyclotron. In this example, the cyclotron comprises two half-cylinders coaxial with the axis 105 of the engine 80″. The two half-cylinders are facing each other and are connected to one or more alternating current generators.

The ion generator 85 is configured to direct the ions produced towards a central region 87a of the ion accelerator 87′, which is a sub-reaction region, that is, the speed of the ions in this region is below a threshold allowing nuclear fusion reactions with the nuclei of the fluid. An outer region 87b of the accelerator is a reaction region, that is, the speed of the accelerated ions in this region is sufficient to allow nuclear fusion reactions with the nuclei of the fluid. As a result, the gamma rays are produced in the reaction region 87b.

Gamma ray shields 109 are preferably positioned between the intake 100 and the accelerator 87′ and/or between the output 92 and the accelerator 87′. This makes it possible to prevent the emission of gamma radiation outside the engine 80″.

Preferably, the sub-reaction region 87a is at least partially protected from the fluid by a protective surface arranged about the axis 105 of the engine, the protective surface being configured to allow the accelerated ions to pass towards the reaction region 87b. The ions can then also flow at a reaction speed in the region 87a.

Advantageously, the heat-conducting fins 108 are positioned on an inner face of the wall 86 and/or the shields 109 so as to promote the heat exchanges with the fluid and the elements absorbing the gamma rays.

A turbine 110 can be arranged at the output 92 of the engine 80″.

FIG. 5 shows a fourth embodiment of an engine 805 according to the invention. The engine 805 uses a cyclotron 120 to accelerate the ions, the fluid passing partially through the cyclotron 805, in which case the cyclotron acts as a maintenance electrode.

The fluid flows through the cyclotron 120 perpendicular to the plane of the figure in spaces 125 arranged between the two dees, or accelerating electrodes, 121, 122. A wall 123, preferably circular, is arranged inside the cyclotron 120, preferably centred on a central axis of the cyclotron. The wall 123 is configured to be impermeable to the fluid, and permeable to the ions at least in a section of the wall 123 provided for the ions to pass through. Advantageously, the wall 123 defines a space 126 empty of fluid, in which the ions can be freely accelerated. The space 126 is advantageously enclosed by walls 127, which form a cylinder with the wall 123. The fluid is thus prevented from flowing in the space 126.

Advantageously, the walls 124 are arranged on faces of the first and/or second dee, the walls 124 being configured to be impermeable to the fluid and permeable to the ions. The walls 124 make it possible to restrict the flow of the fluid to the spaces 125 and prevent the fluid from entering the dees of the cyclotron.

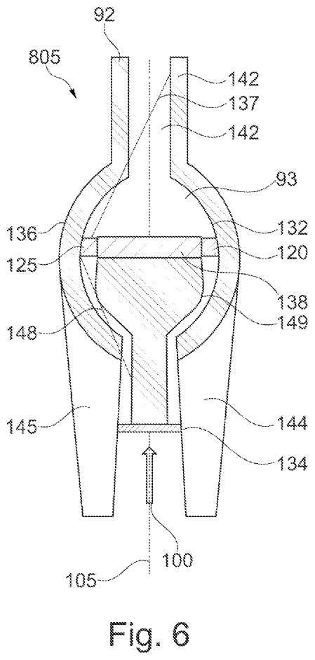

FIG. 6 is a side view of the engine 805 in FIG. 5.

The engine 805 extends along an axis of revolution 105 and comprises an intake 100 towards the chamber 93 and an output 92. A compressor 134 is arranged between the intake 100 and the chamber 93 and is configured to compress a fluid entering the engine. The cyclotron 120 arranged in the chamber 93 heats the fluid. A section 138 of the cyclotron 120, corresponding to the space 126 in FIG. 5, is advantageously empty and provided for the acceleration of the ions.

The nuclear reactions between the accelerated ions and the fluid take place in the space 125 of the chamber 93. The trajectories 137, 148 represent possible trajectories of gamma rays produced by nuclear fusion reactions between the accelerated ions and the fluid. Preferably, a gamma ray shield is arranged in a wall 136 of the engine and/or in a central body 149 arranged between the compressor 134 and the cyclotron 120 and/or in the shields 142, 145 arranged around the intake 100 and/or the output 92 of the chamber 93. The inner surface 132 of the wall 136 allows the wall 136 to transfer to the fluid some of the heat generated by the capturing of the gamma rays in said wall 136. Cooling fins (not shown) can advantageously cover the inside of the surface 132.

The heated fluid leaving the chamber 93 is preferably discharged by a nozzle 142, which allows the acceleration of the fluid.

Other geometries of the engine 805 are possible. In particular, the gamma ray shield arranged in the central body 149 can be arranged in the walls 144, 145 of the engine.

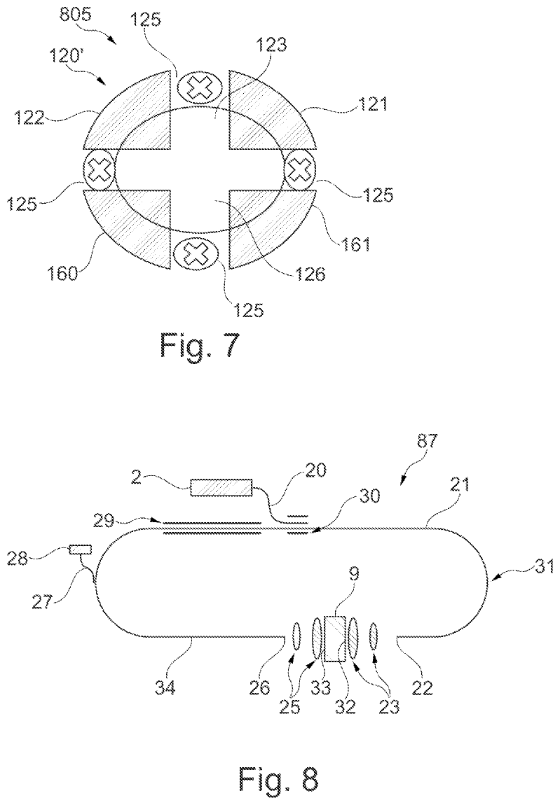

FIG. 7 shows an alternative embodiment of a cyclotron 120′ of the engine 805 illustrated in FIG. 6.

The cyclotron 120′ comprises four dees 121, 122, 123, 124. Having more than two dees advantageously makes it possible to increase the number of spaces 125 in which the fluid can flow. This more evenly distributes the heating and pressure increase of the fluid about the axis of the engine. The number of dees can be odd, for example 3, in which case each of the dees is connected to a different pole of a three-phase power supply.

Advantageously, an electric potential difference is applied between two immediately adjacent dees when an ion burst passes through, allowing their acceleration.

Source Elements

It is possible to use a plurality of isotopes as the source material. However, when the fluid entering the engine is air, isotopes with a stable product of the reaction with nitrogen 14 and oxygen 16 are preferably used. This is in particular the case of lithium 7, which is abundant and the products of fusion with nitrogen 14 and oxygen 16 of which are neon 21 and sodium 23 respectively; boron 11, which is abundant and the fusion products of which are magnesium 25 and aluminium 27 respectively; fluorine 19, which is abundant and the fusion products of which are sulphur 33 and chlorine 35 respectively; beryllium 9, which is abundant and the fusion products of which are sodium 23 and magnesium 25 respectively; or tritium, nitrogen 15 or carbon 13.

“Stable isotope” is given to mean an isotope the half-life of which is greater than 10¹² years.

Walls

The inside of the engine preferably has, on either side of the trajectories of the accelerated ions in the fluid and in the direction of flow of the fluid, fins made from a material that absorbs gamma rays and conducts heat. Preferably, tungsten, iron or stainless steel is used, for example with a thickness of between 0.3 cm and 1 cm, preferably of the order of 0.5 cm. These fins advantageously convert the energy carried by the gamma rays generated by the nuclear fusion reactions into heat and transmit this heat, together with the heat released by the rest of the walls exposed to the gamma rays, to the fluid.

The sections of the inside of the wall 86 of the reactor struck by the ions advantageously consist of or are coated with one or more target materials which, when reacting by fusion with the ions, produce stable isotopes. These can be in particular carbon 12, tungsten 186 or molybdenum 96 or 98 with a thickness of 3 cm to 8 cm, for example 4 cm. The thickness of the target material is selected as a function of the speed of the ions entering the material. However, the dimensions of the cyclotron are advantageously adjusted so that the ions do not strike any elements other than the fluid. The thickness of the walls is then adjusted to protect the outside against gamma rays, as described below.

Maintaining the Speed of the Ions

The ions are slowed down when they enter the fluid. The presence of an electric field within the target, opposing the slowing of said ions, can therefore advantageously be provided. To this end, one or more maintenance electrodes, configured to maintain a constant speed of the ions despite the effects resulting in them slowing down, are positioned in the chamber 93 of the engine. A dielectric body is preferably positioned on either side of the maintenance electrode so that electrons are not detached from it.

Alternatively or in combination, if the ions of the ionized source material are grouped in bursts, a cyclotron can be configured to maintain their speed or to accelerate them when they pass from one cyclotron dee to another. The ions can then enter the cyclotron, preferably already accelerated by an acceleration cyclotron or a linear accelerator, through the outside of the cyclotron, the target ensuring its deceleration or reduced acceleration to the first passage between the two dees, if said target is fully or partially located outside this zone between the two dees. The dee of the cyclotron is not necessarily made up of cylindrical portions, but can have a different shape also making it possible to direct the flux of the fluid flowing and heated therein.

Maintenance Cyclotron and Synchrotron

Alternatively, the ions are produced in bursts in a cyclotron or a synchrotron or are sent into it, for example using an electric field, the fluid optionally but not necessarily flowing between the two half-cylinder electrodes (commonly known as “dees”) of the cyclotron, or between the half-rings of the synchrotron and optionally being held there by membranes permeable to the source ions, the slowing of the ions by the target material being compensated for by the electric field between the dees. If the fluid flows between the two dees, it preferably flows on the inner periphery of the cyclotron, as the speed of the ions is greatest there. Dees can be nested inside each other, making it possible to apply different potential differences between the dees within which the ions flow in a vacuum and the peripheral dees in which the fluid can also flow, thus making it possible for example to modulate the intensity of the electric field used to maintain the speed of the ions as a function of the pressure of said fluid.

System for Ionizing the Source Isotopes

An ionization system 87 that can be used in an engine according to the invention is shown in detail in FIG. 8.

In the example in question, the ionization system 87 comprises a laser 2. The light produced by the laser is guided by the supply waveguide 20 to a reinjection circuit 31.

The supply waveguide 20 is for example a single-mode optical fibre.

The reinjection circuit 31 comprises an input waveguide 21 configured to guide the light flowing in the reinjection circuit 31 towards an optical input 32 of the enclosure 9.

The input waveguide 21 can be a single-mode optical fibre and comprises an end 22 that is advantageously coated with an anti-reflective layer and the end of which is cut and polished to form a lens.

Preferably, a first set of objective lenses 23 coated with anti-reflective layers is arranged between the end 22 of the input waveguide and the optical input 32 of the enclosure 9.

As an alternative to the use of an anti-reflective layer, the system can be configured so that the light leaving the end 22 of the input waveguide follows Brewster's angle, thus avoiding the partial reflection of the light at the interface between the end 22 and the ambient environment (atmosphere or partial vacuum).

Once the light enters the enclosure 9 through the optical input 32, part of the light generated by the laser interacts with the source material 11 in the enclosure 9 so as to ionize the isotopes of the source material.

However, another part of the light is capable of passing through the enclosure 9 without interacting with source isotopes. In order to recover this unabsorbed light, the enclosure 9 can also comprise an optical output 33 configured to recover the unabsorbed light in the enclosure 9.

The light can optionally be reflected in the enclosure by one or more mirrors before it reaches the optical output 33.

Preferably, a second set of objective lenses 25 is arranged between the optical output 33 and the end 26 of an output waveguide 34 in order to facilitate the feeding back thereof into the waveguide 34.

The optical coupling between the optical output 33 and the end 26 can be produced in the same way as the optical coupling between the optical input 32 and the end 22.

The output waveguide 34 is optically connected to the input waveguide 21 to form the reinjection circuit 31.

According to a particular embodiment, the input and output waveguides can form a single optical fibre.

A wave concentration device, such as a device allowing mode blocking, can be incorporated into the laser with the aim of superposing different cycles of a coherent light wave and thus reducing its duration while increasing its instantaneous power.

The duration of a pulse at the output of the wave concentration device advantageously corresponds to a length of the pulse of the order of the wavelength of the coherent wave produced by the laser; the pulse is advantageously repeated at a frequency selected so that the accelerated ions have reached the target before another pulse generates more ions.

The wave concentration device used is known per se. It can be a coherent amplification network as described in the presentation entitled “ICAN and 100 GeV's Ascent”, J. Mourou et al., EuroNNAC, Meeting CERN, 3 May 2012.

Ionization systems using an ionization method other than by laser can also be used within the scope of the invention.

Reinjection Circuit

The reinjection circuit 31, between the end 26 of the output waveguide and the end 22 of the input waveguide, makes it possible to reuse the light passing through the enclosure 9 without interacting with source isotopes.

Preferably, the sum of the optical paths travelled by the light wave, that is, the sum of the distances travelled in each environment multiplied by the refractive indexes of said environments, in a complete optical loop (for example, a loop starting and finishing at the end 22 of the input waveguide), is a whole multiple of the wavelength in a vacuum of the light flowing in the reinjection circuit 31.

The length of certain elements in the loop can vary, for example due to temperature variations. An element having adjustable properties can advantageously be inserted into the loop to control the optical length of said loop.

The adjustable properties of an element can for example be the length of said element or its refractive index.

If the waveguides are optical fibres, it can for example be envisaged to tension a segment of optical fibre using piezoelectric materials or carefully selected temperature-sensitive dimensions.

Alternatively, a waveguide segment can be made from a material, such as lithium niobate, having a refractive index that can be adjusted as a function of physical quantities such as an external electric field, for example, so as to form a Pockels cell.

Adjustment electrodes 29 connected to an electricity generator can thus advantageously be arranged around a waveguide segment with a refractive index that can be adjusted as a function of an electric field, in order to adjust the refractive index of the segment and thereby adjust the optical length of the reinjection circuit 31.

It is also advantageous for the supply waveguide 20 to comprise a segment having an adjustable refractive index, in particular in the event that the reinjection circuit 31 causes light to travel in wave bursts rather than as continuous light. In the embodiment illustrated in FIG. 8, the secondary adjustment electrodes 30 make it possible to adjust the refractive index of a segment of the supply waveguide 20 to allow the light coming from the laser 2 to be injected at a carefully selected moment as a function of the phase of the wave travelling in the waveguide 20.

The reinjection circuit 31 can also comprise an optical amplifier, for example an erbium-doped fibre amplifier, a Raman amplifier or a semiconductor amplifier.

The supply waveguide 20 is configured to inject the light from the laser 2 into the reinjection circuit 31.

Preferably, a reinjection circuit 31 is used when the wave train travelling in the reinjection circuit is at least twice as long as the length of said circuit, to allow part of the light wave passing through the supply waveguide 20 to couple to the light wave travelling in the reinjection circuit.

A control fibre 27 connected to an instrument for measuring the luminous intensity 28 can be juxtaposed with the fibre 34 in order to sample a fixed proportion of the light travelling therein, for example 1%, and thus measure the intensity of the light travelling in said fibre 34.

Ionization System Laser

In the embodiment shown in FIG. 8, the source isotopes are ionized by a laser.

The wavelength of the light produced by the laser is for example 369 nm, 269 nm or 182 nm. The wavelength produced can also be shorter, and lasers with wavelengths as short as 13.5 nm are known.

The light can be produced by laser diodes. A continuous wave laser such as a VECSEL can be used.

A wavelength of 369 nm can be obtained for example by mixing a 1,470 nm laser light with the second harmonic of a 985 nm laser light.

A wavelength of 269 nm can be obtained by using the third harmonic of a laser light with a wavelength of 808 nm.

A wavelength of 182 nm can be obtained by mixing the fifth harmonic of a 1,064 nm laser light with a 1,260 nm laser light. The mechanisms for obtaining the harmonics and mixtures of wavelengths are described for example in WO 2018/128963 A1.

According to a particular embodiment, the laser is used in combination with a mode blocking device or a compressed pulse device making it possible to reduce the duration of the laser pulses while increasing their instantaneous power, such as a coherent amplification network.

The laser beam can be enlarged or focused by optical lenses so that the power per unit area of the laser beam does not exceed the dislocation boundaries of certain materials used in the ionization device.

The size of the lenses is advantageously selected to make it possible to focus the laser beam over a sufficient length in the compartment 41 where the source is ionized and then reach the lenses 25 of the reinjection circuit.

The frequency of the light produced by the laser can be doubled or quadrupled by passing through well-chosen non-linear and non-symmetrical crystals. The frequency can also be multiplied by five by using a harmonic generation method according to which the laser beam passes through a rare gas such as argon.

A 361 nm coherent light produced by a gallium nitride GaN laser diode with a band gap of 3.44 eV can also be used; or a 188 nm coherent light produced by an indium gallium nitride (InGaN) laser in which the proportion of gallium is selected to produce a semiconductor material with a band gap of 3.3 eV, the frequency of which is doubled by passing through a crystal, for example a borate fluoride crystal such as KBe₂BO₃F₂(KBBF), which is transparent to wavelengths as short as 147 nm and withstands powers of up to 9.1011 W/cm².

A 166 nm coherent light produced by a quantum well laser or by a method for generating harmonics by passing two laser beams generated by a titanium-sapphire laser through argon gas at a pressure of 440 mb can also be used.

Linear Acceleration of the Ionized Isotopes

The electric field generated by a generator between the electrodes and the ion accelerator 87 makes it possible to accelerate the ionized isotopes. The generator is configured to generate high voltages, for example greater than 10,000 V and less than 10,000,000 V, preferably allowing nuclear fusion reactions. The generator consists, for example, of a plurality of generators sold by Genvolt under the Perseus name, mounted in series.

In order to avoid the accumulation of ions at low speeds, the electric field selected in the ionization zone is preferably high, but lower than a value capable of causing the breakdown of the ionized gas. The electric field can for example have a value of 4×10⁵ V/m, and the gas can be ionized over a significant thickness, in particular if the section of the illuminating light ray is significant; the ion acceleration voltage is preferably selected so that even the ions produced closest to the membrane are accelerated at the speed allowing them to fuse with the target.

Acceleration Speeds

The ions, for example of boron 11 or lithium 7, can be accelerated with an energy of between 0.1 MeV and 10 MeV. The ions can however be accelerated at lower energies, but in this case their kinetic energy might not be sufficient to cause nuclear fusion reactions.

Source Materials in Gaseous Form

If the source material is in gaseous form, it can be injected into the ionization enclosure by means of an expansion valve. However, when the source isotopes are in gaseous form and are consumed by ionization at volumes and rates that do not allow their uniform replacement, or in order to concentrate the production of ions in the electric field, the source gas is preferably conveyed into the ionization enclosure of the ionization system 85 by means of a first pipe the end of which that emerges into the ionization enclosure forms a nozzle.

The gas is then preferably sucked towards a second pipe arranged in line with the nozzle of the first pipe. The end of the second pipe emerging into the ionization enclosure is preferably funnel-shaped.

The first and second pipes are preferably connected to a pump making it possible to accelerate the flow of the gas in the pipes, and to a source gas reserve making it possible to inject the gas into the device and add gas as it is consumed.

In this case, the source gas flows in a gas flow circuit.

A filtering device making it possible to filter the flowing gas in order to remove the impurities from it can advantageously be arranged in the gas flow circuit.

A device configured to produce a vacuum in the compartment of the ionization enclosure in which the gas flows and optionally to reinject the source gas into the circuit can advantageously be used.

Neutron Shields

If the nuclei of the fluid or parts of the engine struck by the accelerated ions are capable of producing neutrons after fusion, a protective wall capturing the neutrons is preferably arranged around the engine.

The protective wall capturing the neutrons can contain a material that slows down the neutrons such as water, preferably in liquid form, or calcium hydride CaH₂, preferably below its melting temperature of 816° C., into which boron tubes or balls or tubes containing helium 3 can be plunged. A 10 cm thickness of water can divide the number of rapid neutrons passing through the shield by approximately 2.7.

Gamma Ray Shield

The chamber 93 in which fusion occurs, and also the ionization enclosure and the neutron shield if neutrons are capable of being produced, are preferably surrounded by a protective wall absorbing the gamma rays. Such a wall is for example made from lead with a thickness of 35 cm or tungsten with a thickness of 21 cm, in order to protect the environment from the gamma rays that the nuclear reactions produce and convert them into heat.

An iridium wall can also be used.

The gamma ray shield is preferably the wall 86 defining the chamber 93 of the engine.

The gamma ray shield is preferably cooled by an internal flow of a heat-transfer liquid or chemical compounds reacting endothermically so as to simultaneously cool said radiation shield, capture the energy produced by the nuclear reaction, convert said energy into chemical energy or carry out one of the desired chemical transformations.

The liquids flowing in the gamma ray shield also absorb gamma rays. The thickness of the gamma ray shield is preferably configured so that the dose of radiation that escapes from the device per year, and at any time, does not exceed the regulatory health protection limits.

Shield Geometry

A configuration allowing the diversion of the trajectory of the ions in their acceleration beam using magnetic fields and optionally intermediate electrodes is preferably used, so as to protect the environment and optionally the ionization chamber from the gamma rays that could travel in the ion flow channels. The ions produced in the ionization chamber can for example bypass a gamma ray protective wall separating the nuclear reaction chamber 93 from the ionization chamber.

The configuration can be further improved by making the ion beam pass through a non-straight cavity, for example spiral, positioned in the gamma ray absorbing material so that no gamma rays can travel in a straight line from their production location to the inlet of the channel. The same is true of the other cavities making it possible for example to discharge the material produced, in particular if they are gaseous and only have a low capacity for absorbing gamma rays. For the cavities of the chambers 93 that have orifices to allow through the fluid flux, the ion beam can advantageously be restricted to the periphery or conversely to the centre thereof, so that the intakes and outputs of said reactor are all separated from the nuclear reaction location by a gamma ray shield, as shown for example in FIG. 1.

Ultraviolet and X-Ray Shields

The ionization enclosure of the ionization system 85 is advantageously protected by a stainless steel wall, for example having a thickness of between 1 mm and 5 mm, in particular 2 mm, if the wavelength of the light used for ionization is less than 100 nm.

X-rays can be generated, in particular in a plane perpendicular to the acceleration in the ion accelerator 87 or to the deceleration of the ions in the chamber 93 or when they are diverted, in particular if the engine comprises a cyclotron or a synchrotron. The gamma ray shield advantageously allows protection from these X-rays if the deceleration or acceleration takes place in the chamber 93 through which the fluid passes. However, a specific shield must be placed around other locations in which such accelerations, changes of direction or decelerations can take place, in particular around the ion accelerator 87 and around the synchrotron and the cyclotron.

Sensors

Sensors controlling in particular the deformation, the temperature and the acceleration of the structures of the device and in particular the gamma ray shield devices are advantageously used to stop the acceleration and/or production of ions before they heat abnormally or lose some of their shields, in particular the gamma ray and neutron shields.

The invention is not limited to the examples described above. In particular, the devices and methods cited or illustrated can be combined in different ways to form other variants not illustrated.

1. An engine comprising:
a chamber comprising an intake and an output for a fluid;
a first enclosure configured to contain a source material;
a system for at least partially ionizing the source material;
an ion accelerator configured to accelerate the ionized source material towards the chamber so as to cause the fusion of atomic nuclei of the ionized source material with atomic nuclei of the fluid.

2. The engine according to claim 1, wherein the chamber comprises a plurality of fins, preferably made from a heat-conducting material such as a metal, in particular tungsten, iron or stainless steel, the fins being configured to absorb gamma radiation emitted by the fusion of the nuclei of the source material with the nuclei of the fluid.

3. The engine according to claim 1, wherein the walls of the chamber comprise one or more first target materials, the ion accelerator being configured to accelerate the ionized source material towards the first target materials so as to cause the fusion of nuclei of the ionized source material with the nuclei of the first target materials, preferably forming a stable isotope, said first target materials preferably forming a coating of the inner walls of the chamber.

4. The engine according to claim 1, wherein the chamber comprises one or more maintenance electrodes (98) configured to form an electric field accelerating the ionized source material.

5. The engine according to claim 1, wherein the outer walls of the chamber are coated with a shield configured to reflect heat radiation towards the inside of the chamber.

6. The engine according to claim 1, further comprising a second enclosure arranged between the first enclosure and the chamber and comprising a second target material, the ion accelerator being configured to accelerate the ionized source material towards the second target material so as to cause the fusion of nuclei of the ionized source material with nuclei of the second target material.

7. The engine according to claim 1, wherein the second target material is a fluid flowing in a second target material cooling circuit.

8. The engine according to claim 6, wherein the second enclosure comprises a heat-transfer liquid, the heat-transfer liquid flowing in a heat-transfer liquid cooling circuit.

9. The engine according to claim 7, wherein the second target material cooling circuit and/or the heat-transfer liquid cooling circuit is configured to transmit the heat recovered to a device for converting heat energy into electricity.

10. The engine according to claim 1, wherein the chamber comprises at least one shield against gamma radiation configured to prevent the emission of gamma radiation through the intake and/or output of the chamber.

11. The engine according to claim 1, further comprising one or more sensors configured to measure the deformation of the engine and/or the temperature of the engine and/or the acceleration of parts of the engine.

12. The engine according to claim 1, wherein the fluid is a gas, in particular air.

13. The engine according to claim 1, wherein the fluid is an alkane, in particular methane.

14. The engine according to claim 1, wherein the source material is an isotope that produces a stable isotope on fusion with nitrogen 14 and/or oxygen 16, preferably lithium 7, boron 11, fluorine 19, beryllium 9, tritium, nitrogen 15 or carbon 13, or the source material is an isotope that produces a stable isotope on fusion with carbon 12 and/or hydrogen, preferably sodium 23 or fluorine 19.

15. The engine according to claim 1, further comprising a filter, in particular a bag filter, configured to separate carbon and hydrogen, the filter being arranged at the output of the chamber.

16. The engine according to claim 1, further comprising an electricity-generating turbine arranged at the output of the chamber.

17. The engine according to claim 1, wherein the ion accelerator comprises a high-voltage generator, electrically connected to a first electrode arranged in the first enclosure and to a second electrode, the second electrode being arranged in the chamber, the generator and the first and second electrodes being configured to generate an electric field making it possible to accelerate the ionized source material towards the chamber so as to cause the fusion of the atomic nuclei of the ionized source material with atomic nuclei of the fluid.

18. The engine according to claim 1, wherein the ion accelerator comprises a cyclotron and/or a synchrotron configured to accelerate the ionized source material towards the chamber so as to cause the fusion of the atomic nuclei of the ionized source material with atomic nuclei of the fluid.

19. The engine according to claim 1, further comprising a second cooling circuit configured so that a second heat-transfer liquid flows in the walls of the chamber, the heat transported by the second heat-transfer liquid preferably being used to generate electricity.

20. The engine according to claim 1, further comprising an ion thruster arranged at the output of the chamber and configured to accelerate the fluid leaving the chamber.

21. The engine according to claim 1, further comprising a fluid reserve fluidly connected to the intake of the chamber.

22. The engine according to claim 1, wherein the fluid is stored in gaseous or liquid form in the fluid reserve or the fluid is a gas produced by chemical reaction of a liquid stored in the fluid reserve, in particular by combustion.

23. The engine according to claim 1, forming a ramjet engine.

24. The engine according to claim 1, further comprising a compressor arranged at the intake of the chamber and forming a turbojet engine.

25. An aircraft comprising an engine according to claim 23.

26. A spacecraft comprising an engine according to claim 1.
